(19) United States
(12) Patent Application Publication
(10) Pub. No.: US 2007/0181521 A1
(43) Pub. Date: Aug. 9, 2007

(54) Towel and bottle system

(76) Inventor: Lisa Collins, Brea, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/346,853

(22) Filed: Feb. 3, 2006

(51) Int. Cl. A47J 41/02

(52) U.S. Cl. 215/12.1

(57) ABSTRACT

This invention is a towel that attaches onto a drinking bottle and allows a person to quickly wipe and absorb fluids off their body. It acts as a guard against spills by the person drinking. The towel is made of lightweight, soft, and absorbent materials, which may be disposable or washable. An alternative embodiment can be attached to a canteen, to provide an emergency filed dressing kit.

### BACKGROUND OF THE INVENTION

1. Field of the Invention

The present invention relates to a towel that is attachable to a drinking bottle at both neck and bottom. The towel is easily accessible for wiping up water or other fluid. It is made of absorbing material that can be disposable or washable and that is lightweight and soft. It is either washable and reusable in one embodiment, or disposable in another embodiment.

2. Description of Related Art

No prior art was found that teaches the present invention.

Much of the prior art teaches towels attachable to beach chairs and furniture, rather than to a bottle. In U.S. design Pat. No. D500,231, issued on Dec. 28, 2004 to inventors Ward and Nole, the design for a thermos bottle with permanently attached sleeve was disclosed. The sleeve may be a towel-like material, but the precise composition is not disclosed.

U.S. Pat. No. 5,441,789, issued on Aug. 15, 1995 to inventor G. Walker, presents an invention of a beach towel attachable to outdoor chairs, loungers, and the like. U.S. Pat. No. 5,640,721, dated Jun. 24, 1997, to inventor R. Jackson, describes a sweatband with wiping towel. It is designed to be attached to the head of a person.

U.S. Pat. No. 6,182,309, issued on Feb. 6, 2001 to inventor W. Sullivan, teaches a beach towel with attached pillow and various straps.

Another series of prior art is focused on the prevention of bottle spillage, contamination, or breakage. U.S. Pat. No. 1,683,205 teaches a device that attaches to the bottom of a cup or bottle to catch drips and spills. U.S. Pat. Nos. 2,706,571 and 3,405,829 relate to rigid devices that cover the bottle for purposes of preventing breakage of the bottle. U.S. Design Pat. No. D458,380 teaches a decorated protective collar that slides over the bottle cap.

### SUMMARY OF THE INVENTION

The present invention relates to a towel that is attachable to a drinking bottle at both neck and bottom. The towel is easily accessible for wiping and drying up fluids. It is made of absorbing material that can be disposable or washable and that is lightweight and soft. It is either washable and reusable in one embodiment, or disposable in another embodiment.

The towel has means for removable attachment to a bottle at opposite ends of the towel. In one embodiment, the means comprise a pair of straps attached to each end of the towel. The straps can be constructed of elastic material, hook and loop and/or snap attachment elements. These elements, plus the design of the towel, allow it to fit snugly around a drinking bottle. The towel can at any time be detached at the bottom, or completely detached, to use separately from the bottle.

### BRIEF DESCRIPTION OF THE DRAWINGS

The invention will now be described, by way of example only, with references to the accompanying drawings, as follows:

### BRIEF DESCRIPTION OF THE DRAWINGS

The invention will now be described, by way of example only, with references to the accompanying drawings, as follows:

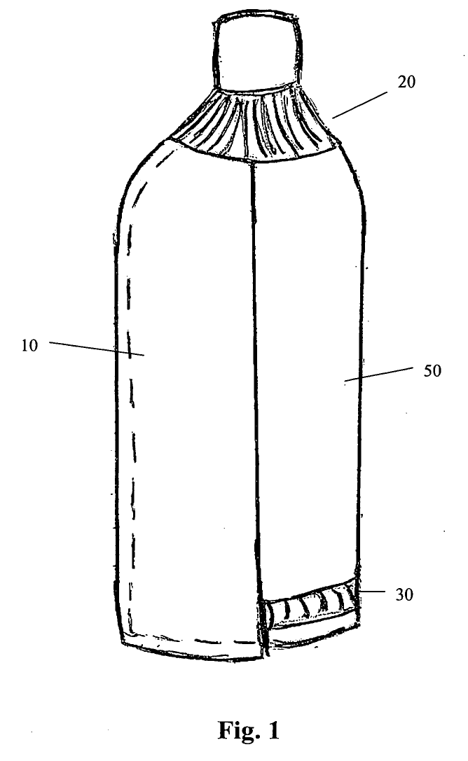

FIG. 1 depicts the invention from a side view, with the towel on the left hand side of the bottle. This shows the preferred embodiment, with a towel comprising a disposable synthetic material.

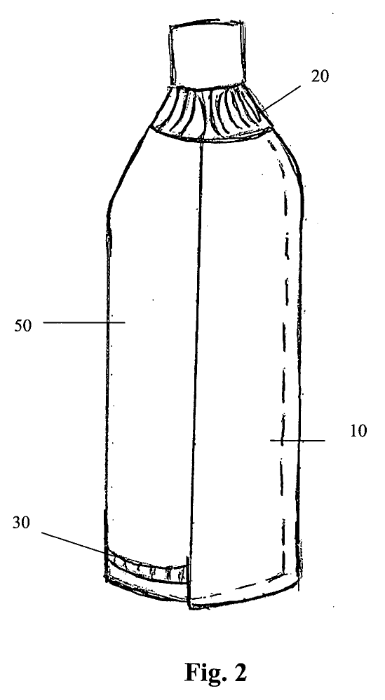

FIG. 2 depicts the invention from the opposite, right side, with the towel on the right hand side of the bottle.

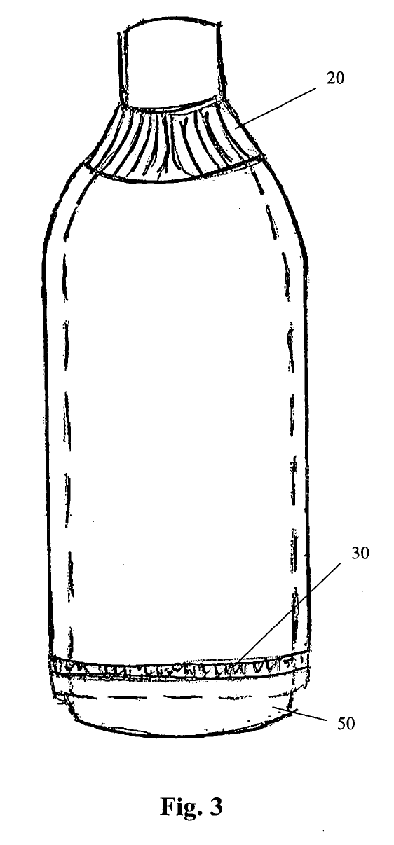

FIG. 3 depicts the invention from the rear. The towel is behind the bottle. Only the neck and bottom straps are visible from this view.

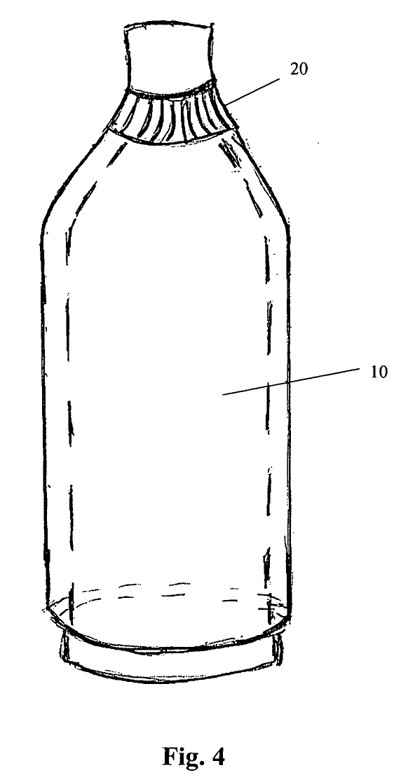

FIG. 4 depicts the invention from a frontal view. In this view can be seen the ribbing material around the aperture at the neck of the bottle. The lower strap is hidden from view.

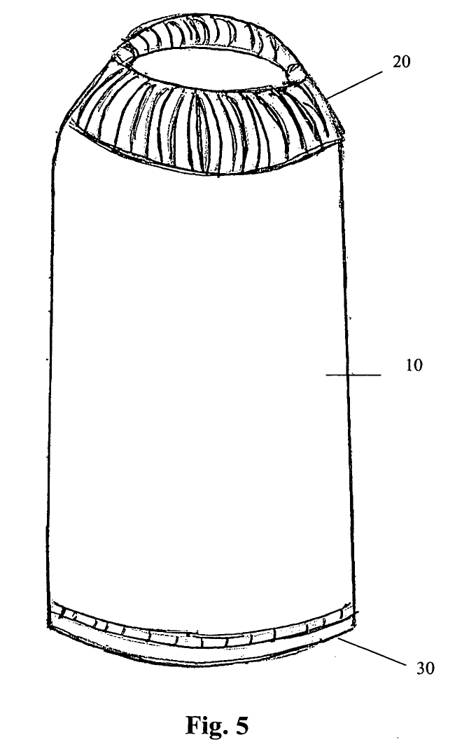

FIG. 5 depicts the towel of the present invention alone and standing without a bottle.

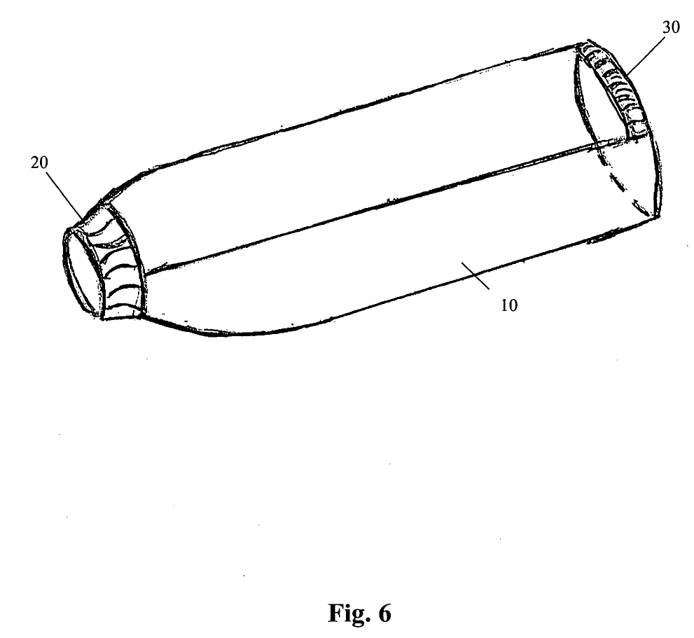

FIG. 6 depicts the towel of the present invention alone, lying along its long axis, without a bottle.

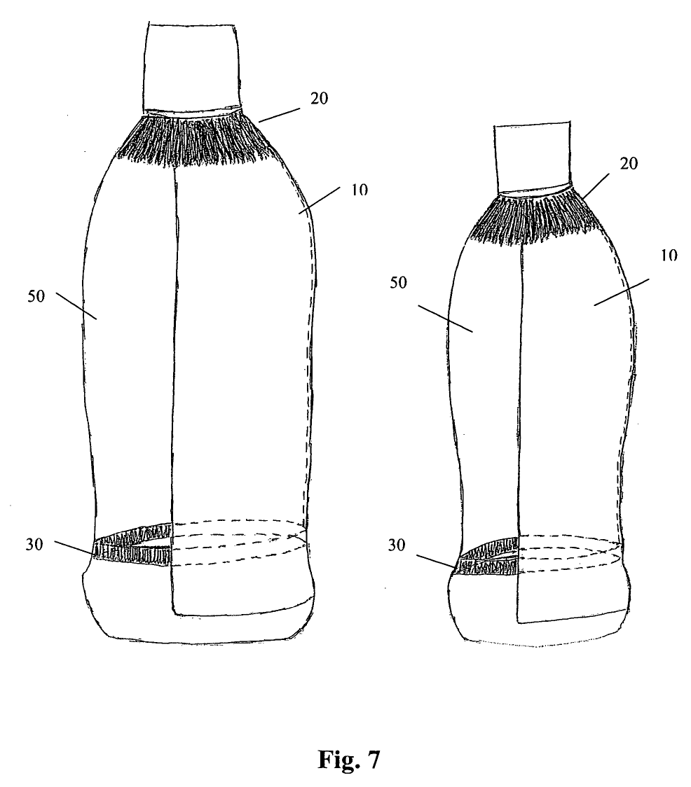

FIG. 7 depicts the invention in differing sizes of bottle and towel according to the present invention.

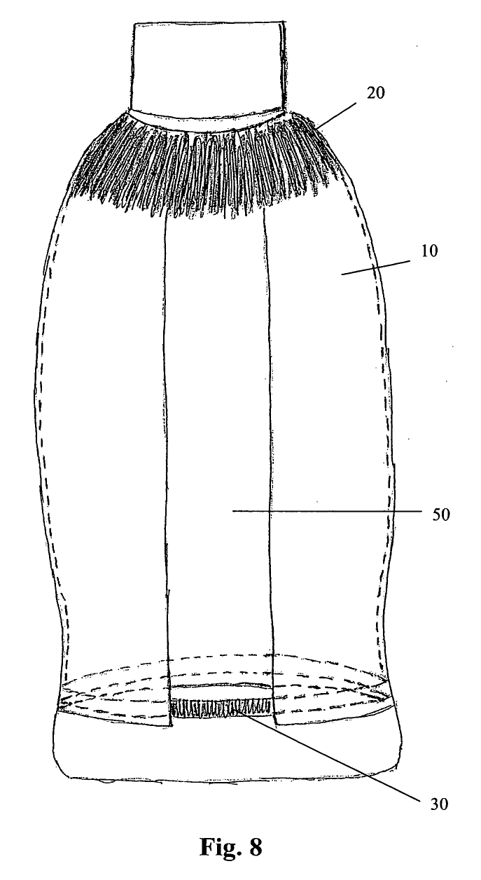

FIG. 8 depicts the invention from the rear view. The towel extends around nearly the entire circumference of the bottle. A small section of the bottle is visible, uncovered by the towel.

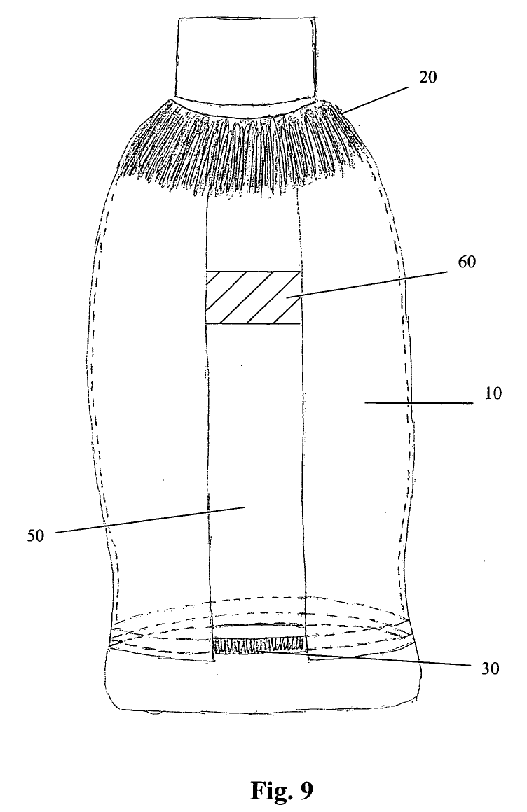

FIG. 9 depicts a canteen version of the present invention from the rear.

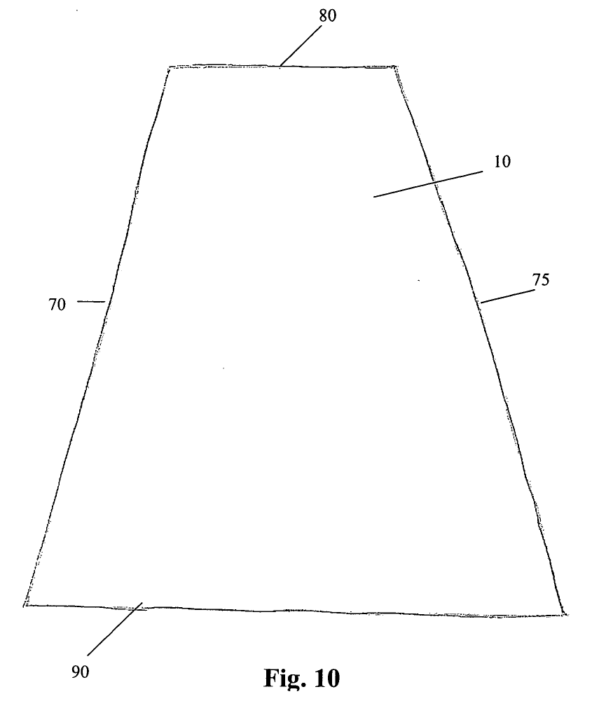

FIG. 10 depicts the shape of towel that is used as a starting point for construction of the present invention.

### DETAILED DESCRIPTION OF THE INVENTION

The present invention relates to a towel that is attachable to a drinking bottle at both neck and bottom. The towel is easily accessible for wiping up and absorbing water or other fluid. It is made of absorbing material that can be disposable or washable, and that is lightweight and soft. It is either washable and reusable in one embodiment, or disposable in another embodiment.

The disposable materials in a preferred embodiment of the current invention have been specially made for liquid absorption, such as paper or cotton batting or quilting materials. In its preferred embodiment, the towel material consists of a plurality of layers. For example, in a preferable mode, the invention comprises a three layer material consisting of a bottom layer of lightweight lining, an inner layer of a soft and absorbent cotton or synthetic batting or quilting covered by a top layer of semi-permeable or directionally-permeable material that captures liquid in such a way that it is absorbed into the inner absorbent layer, while the surface of the material stays dry or nearly dry. The exact material and construction can vary, but it is essential that the material be absorbent and liquid-capturing.

In another embodiment of the current invention, the towel can be constructed of a reusable, washable cloth. Terrycloth or cotton weave are preferred materials. The towel should be capable of absorbing moisture, and should be soft to the touch.

In FIG. 1 is seen the towel system of the present invention. The towel body 10 fits snugly on the outside wall of a sports bottle 50. The towel is secured to the bottle by an upper neck ring 20 and a lower attachment element 30. These attachment means can be present in various embodiments, but as drawn, the upper attachment 20 is a ribbed neck ring, and the lower attachment element 30 is an elastic strap, hook and loop, or different type of fasteners.

The neck ring 20 is a vital feature of the present invention. This enables the towel to be slipped easily over the neck of a bottle or similar vessel. The towel is then fastened to the body of the bottle, near the base, by closing the fastening element 30.

FIG. 2 portrays the towel system of the present invention from the opposite side. The towel body 10 remains snugly on the outside wall of a sports bottle 50. The towel is secured to the bottle an upper neck 20 and a lower attachment 30. Similar views of the towel system on a sports bottle are displayed from the back in FIG. 3, and from the front in FIG. 4.

The towel without a bottle is shown in FIG. 5. Both attachment rings 20, 30 are designed to be attachable to and removable from the bottle. Removal can be accomplished by simply slipping the bottle out of the lower, then the upper ring.

In another embodiment of the current invention, the upper and lower attachment means are comprised of hook-and-loop material. Preferable for the lower attachment means, the embodiment contains two straps that can be adjusted to the circumference of the bottle. Hook-and-loop material on the surfaces of the straps allows the straps to engage each other and to thereby be secured to the bottle. Alternatively, the straps can be engaged with snaps placed on the straps. Other means for attachment and later removal will also serve as attachment means.

FIG. 6 depicts the towel of the present invention lying on its side, after removal from a bottle. The towel may lie flat, or it may be forced into a curved geometry, because the tension in attachment rings 20, 30 may force the towel into a curved form, as shown here. Ordinarily, the towel would remain flat, or nearly so, when not attached to a drinking vessel.

The bottles to which the towel attaches can be of various sizes. FIG. 7 shows bottles in two sizes, with towels in similar sizes attached. Ideally, the towel size is matched to the bottle size. But it is possible, within certain limits, to attach a small towel to a large bottle, or a large towel to a small bottle. The towel, for instance, can be longer than depicted, and indeed may exceed the length of the bottle to which it is attached. In the latter case, the lower ring or strap 30 can assist in the gathering of the excessive length of towel at the bottom of the bottle.

FIG. 8 shows a Large 32 ounce bottle with towel. This shows that the towel 10 can also vary in horizontal length. In this case, as in FIG. 9 to follow, the towel extends almost the entire circumference of the bottle. Only a section of bottle 50 is left uncovered by towel.

That the system is not limited to sports bottles is shown by example in FIG. 9. Here is displayed a canteen with attached towel. The towel is of particular utility when carried into remote reaches with a canteen. The canteen may be of the ordinary type, or of modern collapsible design. The towel can be used as an emergency field dressing, for instance.

Additionally, thin packets 60 stored on the underneath of the towel 10, between towel undersurface and bottle, can carry sterile gauze dressings, medicines, dried food, or the like. The packet 60 could be partially obscured by the towel, as shown here, or completely covered by the towel. This enables the present invention to become a personal emergency field dressing kit.

FIG. 10 shows the towel body 10, before attachment rings are added. Note that the preferred shape is that of a trapezoid, with top edge 80 parallel to bottom edge 90. The two sides 70, 75 are inclined equally far away from the vertical, such that were the sides allowed to extend until they intersect, the result would be an isosceles triangle, i.e. a triangle with two equal sides, in this case both longer than the length of the bottom edge.

The trapezoidal shape of FIG. 10 is best for producing a towel that will fit snugly against the side of a conventional bottle. For a 24 ounce sports bottle, the dimensions of the sides of the towel in FIG. 10 are these: top edge 80 is 6½ inches in length; bottom edge 90 is 7 inches in length; and sides 70 and 75 are each 6¾ inches long. This results in a towel, after top ring is attached, suitable for a bottle with a ¾ inch (outer diameter) neck.

For this and selected other types of drinking bottles, the dimensions are given in Table I.

TABLE I
Towel Dimensions for sport bottles

All lengths in inches

| | | Top | | | |
|---|---|---|---|---|---|
| Bottle | Bottle | edge | Bottom | Sides | Top |
| Size | Type | length | length | length | aperture |
| 24 oz | sports | 6.5 | 7.0 | 6.25 | 0.75 |
| 26 oz | sports | 7.0 | 7.0 | 7.0 | 0.875 |
| 32 oz | wide | 8.0 | 9.0 | 6.38 | 1.0 |
| | mouth | | | | |
| 1.0 liter | regular | 7.0 | 7.5 | 8.5 | 0.75 |
| 1.5 liter | regular | 8.0 | 8.5 | 10.0 | 0.75 |

While the present invention has been described in terms of several preferred embodiments, it is not intended to limit the invention to the particular forms set forth. On the contrary, the present invention is intended to cover such alternatives, alterations, modifications, and equivalent structures and devices as may be included within the spirit and scope of the invention as defined within the appended claims.

I claim:

1. A towel, comprising the elements of:
a flat towel base, capable of absorbing water;
said towel base having a plurality of attachment elements attached thereon; wherein at least one said attachment element comprises a ring.

2. A device comprising the towel of claim 1, and a drinking vessel, wherein said attachment elements allow said towel to be removably attached to the outer surface of said drinking vessel.

3. The towel of claim 1, wherein said towel surface is formed in the shape of a trapezoid.

4. The towel of claim 1, wherein at least one of said attachment elements comprise straps.

5. The towel of claim 1, wherein at least one of said attachment elements comprise hook and loop fastening means.

6. The device of claim 2, wherein said drinking vessel comprises a bottle.

7. The device of claim 2, wherein said attachment elements are capable of removably attaching said towel to the bottle at the neck of said bottle, and around the body thereof, near the bottom of said bottle.

8. The device of claim 2, wherein said drinking vessel comprises a canteen.

9. A device comprising the elements of:
a towel, capable of absorbing water;
said towel having at least two attachment portions thereon, wherein at least one said attachment element comprises a ring; and,
a drinking vessel,
wherein said attachment portions allow said towel to be removably attached to the surface of said drinking vessel.

10. The device of claim 9, wherein said drinking vessel comprises a bottle.

11. The device of claim 9, wherein said towel is formed in the shape of a trapezoid.

12. The device of claim 9, wherein said attachment portions comprise straps.

13. The device of claim 9, wherein said attachment portions comprise hook and loop fastening means.

14. The device of claim 9, wherein said drinking vessel comprises a canteen.

15. The device of claim 9, wherein said attachment portions are capable of removably attaching said towel to the bottle at the neck, and around the body thereof, near the bottom of said bottle.

16. A towel as described in claim 1, further comprising a packet attached to the underside of the towel, said packet capable of containing small items.

17. A towel as described in claim 1 in which said towel is further comprised of a single integral piece of construction, without need for assembly or fastening by the user, other than at two points near either end of said drinking vessel.

18. A towel as described in claim 1 in which said towel is further comprised of lightweight and soft, absorbent cloth.

19. A towel as described in claim 1 in which said towel is further comprised of a disposable cloth-like synthetic material, which is capable of absorbing liquid.

20. The method for producing the device of claim 2, comprising the steps of:
Producing a towel in trapezoidal form;
Attaching a connection ring to the top edge of said towel;
Attaching a connection means to the bottom edge of said towel; and,
Removably attaching said towel to a drinking vessel via said attachment means and said attachment ring, wherein said ring is attached near the top of said vessel, and said attachment means are attached near the bottom of said vessel.
